(19) United States
(12) Patent Application Publication
(10) Pub. No.: US 2022/0376553 A1
(43) Pub. Date: Nov. 24, 2022

(54) POWER RECEIVING DEVICE AND WIRELESS POWER TRANSFER SYSTEM

(71) Applicant: Mitsubishi Electric Corporation, Tokyo (JP)

(72) Inventors: Hidehito YOSHIDA, Tokyo (JP); Tomokazu SAKASHITA, Tokyo (JP); Takuya NAKANISHI, Tokyo (JP)

(73) Assignee: Mitsubishi Electric Corporation, Tokyo (JP)

(21) Appl. No.: 17/773,616

(22) PCT Filed: Dec. 26, 2019
(86) PCT No.: PCT/JP2019/051150

§ 371 Date: May 2, 2022

(51) Int. Cl. H02J 50/12; H02M 1/08; H02M 7/217; H02M 1/00

(52) U.S. Cl. CPC H02J 50/12; H02M 1/08; H02M 7/217; H02M 1/0009

(57) ABSTRACT

A power receiving device of a wireless power transfer system receives power from a power transmitting circuit connected to a power source and having a power transmitting coil. The power receiving device includes a power receiving circuit, a power converter, an LC filter, and switches which are controlled by a control device on the basis of voltage detected by voltage detection means for detecting output voltage of the power receiving circuit, so that conduction between the power receiving circuit and the power converter is interrupted during a non-power-transfer period.

### TECHNICAL FIELD

The present disclosure relates to a power receiving device and a wireless power transfer system.

### BACKGROUND ART

in wireless power transfer technology, power is transmitted through magnetic field coupling between two coils spaced from each other. There are various methods for adjusting transferred power in wireless transfer technology, many of which are performed by controlling a power converter on the power transmission side. However, in many cases, loads to which wireless power transfer technology is applied are power storage elements such as batteries, and therefore it is desirable that power control is performed at a power converter on the load side (power reception side), in order to adjust transferred power in accordance with the charge condition of such a power storage element. For the above reasons, various methods have been reported as a method for controlling transmitted power by only a power converter on the power reception side (see, for example, Patent Document 1).

In a power receiving device disclosed in Patent Document 1, two power converters are connected to a coil for receiving AC power from a power transmission side, the first power converter on the coil side rectifies AC voltage to DC voltage, and the second power converter connected to the first power converter converts the rectified DC voltage to desired DC voltage or AC voltage. Then, transmission efficiency from the transmission side is controlled by one power converter, and received power is controlled by the other power converter. Thus, control of the transmission efficiency and power control for transferred power are both achieved using only the power converters on the power reception side.

### CITATION LIST

### Patent Document

Patent Document 1: Japanese Laid-Open Patent Publication No. 2017-93094

### SUMMARY OF THE INVENTION

### Problems to be Solved by the Invention

The control method disclosed in Patent Document 1 includes a short-circuit mode in which the power receiving coil is short-circuited through operation of the first power converter so as not to supply power to a stage subsequent to the first power converter. Therefore, this is a method that can be applied to a resonator configuration in which output from a coil operates as a current source. However, in a case of configuring a resonator operating as a voltage source, overcurrent occurs, leading to heat generation and breakage of switching elements. Therefore, for adopting the method described in Patent Document 1, it is necessary to use a specific resonator configuration.

The present disclosure has been made to solve the above problem, and an object of the present disclosure is to provide a power receiving device in which power from a power receiving coil can be interrupted by opening a circuit and thus power control can be achieved by a power converter on the power reception side.

### Solution to the Problems

A power receiving device according to the present disclosure is a power receiving device of a wireless power transfer system and includes: a power receiving circuit which has a power receiving coil and receives AC power transmitted from a power transmitting circuit; a power converter for converting AC power received by the power receiving circuit to DC power; voltage detection means for detecting output voltage of the power receiving circuit; at least one switch for performing switching between a conductive state and an opened state of a circuit between the power receiving circuit and the power converter; and a control device for controlling the switch on the basis of the voltage detected by the voltage detection means.

### Effect of the Invention

In the power receiving device according to present disclosure, power from the power receiving coil can be interrupted by opening the circuit, thus making it possible to perform power control using a power converter on the power reception side, in a resonator configuration operating as a voltage source.

### BRIEF DESCRIPTION OF THE DRAWINGS

FIG. 1 is a schematic configuration diagram showing an example of a wireless power transfer system according to embodiment 1.

FIG. 2 is a schematic circuit diagram showing the configuration of a power receiving device according to embodiment 1.

FIG. 3A illustrates operation of the power receiving device shown in FIG. 2.

FIG. 3B illustrates operation of the power receiving device shown in FIG. 2.

FIG. 4A illustrates operation of the power receiving device shown in FIG. 2.

FIG. 4B illustrates operation of the power receiving device shown in FIG. 2.

FIG. 5A schematically shows waveforms of signals in the power receiving device according to embodiment 1, and illustrates a basic control method for power control.

FIG. 5B schematically shows waveforms of signals in the power receiving device according to embodiment 1, and illustrates a basic control method for power control.

FIG. 5C schematically shows waveforms of signals in the power receiving device according to embodiment 1, and illustrates a basic control method for power control.

FIG. 6A schematically shows waveforms of signals in the power receiving device according to embodiment 1, and illustrates an example of a control method for power control.

FIG. 6B schematically shows waveforms of signals in the power receiving device according to embodiment 1, and illustrates another example of a control method for power control.

FIG. 6C schematically shows waveforms of signals in the power receiving device according to embodiment 1, and illustrates still another example of a control method for power control.

FIG. 7 is a schematic circuit diagram showing the configuration of a power receiving device according to embodiment 2.

FIG. 8 shows a current route during a non-power-transfer period in the configuration shown in FIG. 7.

FIG. 9A schematically shows waveforms of signals in the power receiving device according to embodiment 2, and illustrates an example of a control method for power control.

FIG. 9B schematically shows waveforms of signals in the power receiving device according to embodiment 2, and illustrates an example of a control method for power control.

FIG. 9C schematically shows waveforms of signals in the power receiving device according to embodiment 2, and illustrates an example of a control method for power control.

FIG. 10 is a schematic circuit diagram showing the configuration of a power receiving device according to embodiment 3.

FIG. 11A schematically shows waveforms of signals in the power receiving device according to embodiment 3, and illustrates a drive signal pattern I used in inductor current control.

FIG. 11B schematically shows waveforms of signals in the power receiving device according to embodiment 3, and illustrates a drive signal pattern II used in inductor current control.

FIG. 11C schematically shows waveforms of signals in the power receiving device according to embodiment 3, and illustrates a drive signal pattern III used in inductor current control.

FIG. 11D schematically shows waveforms of signals in the power receiving device according to embodiment 3, and illustrates a drive signal pattern IV used in inductor current control.

FIG. 12A is a flowchart for performing power control by inductor current control in the power receiving device according to embodiment 3.

FIG. 12B is a flowchart for performing power control by inductor current control in the power receiving device according to embodiment 3.

FIG. 12C is a flowchart for performing power control by inductor current control in the power receiving device according to embodiment 3.

FIG. 12D is a flowchart for performing power control by inductor current control in the power receiving device according to embodiment 3.

FIG. 12E is a flowchart for performing power control by inductor current control in the power receiving device according to embodiment 3.

FIG. 13 is a schematic circuit diagram showing the configuration of a power receiving device according to embodiment 4.

FIG. 14A schematically shows waveforms of signals in the power receiving device according to embodiment 4, and illustrates an example of a control method for power control.

FIG. 14B schematically shows other waveforms of signals in the power receiving device according to embodiment 4, and illustrates an example of a control method for power control.

FIG. 14C schematically shows still other waveforms of signals in the power receiving device according to embodiment 4, and illustrates an example of a control method for power control.

FIG. 15 is a hardware configuration diagram of a control device.

### DESCRIPTION OF EMBODIMENTS

Hereinafter, embodiments will be described with reference to the drawings. In the drawings, the same reference characters denote the same or corresponding parts.

### Embodiment 1

Hereinafter, a wireless power transfer system according to embodiment 1 will be described.

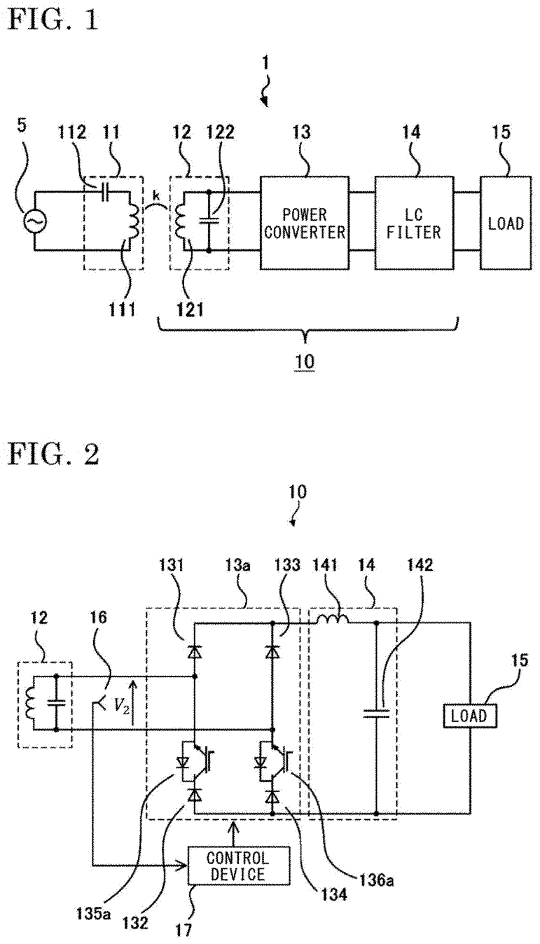

FIG. 1 shows a schematic configuration of the wireless power transfer system according to embodiment 1. In FIG. 1, the wireless power transfer system 1 includes a power transmitting circuit 11 for transmitting power supplied from an AC power supply 5 which is a main power supply, and a power receiving device 10 which receives power from the power transmitting circuit 11 and outputs power to a load 15. The power receiving device 10 includes a power receiving circuit 12, a power converter 13, and an LC filter 14.

Power supplied from the AC power supply 5 is transmitted in a contactless manner between the power transmitting circuit 11 and the power receiving circuit 12. The power converter 13 serves as a power converter that converts AC power received by the power receiving circuit 12 to DC power and adjusts the received power to preset power. The LC filter 14 attenuates an AC component contained in output power from the power converter 13. The power outputted from the LC filter 14 is, for example, consumed or stored in the load 15.

The power transmitting circuit 11 is a circuit that includes at least one coil, and in FIG. 1, is composed of a power transmitting coil 111 and a power-transmission-side capacitor 112 connected in series. The power-transmission-side capacitor 112 is not essential for wireless power transferring, but if the power-transmission-side capacitor 112 is not present, power transmission efficiency between the power transmitting and receiving coils is significantly reduced. Therefore, it is desirable to use the power-transmission-side capacitor 112 so as to improve the power factor.

The power receiving circuit 12 is a circuit that includes at least one coil, and in FIG. 1, is composed of a power receiving coil 121 and a power-reception-side capacitor 122 connected in parallel. The power-reception-side capacitor 122 is not essential for wireless power transferring, but if the power-reception-side capacitor 122 is not present, power transmission efficiency between the power transmitting and receiving coils is significantly reduced. Therefore, it is desirable to use the power-reception-side capacitor 122 so as to improve the power factor.

Depending on the configurations of the power transmitting circuit 11 and the power receiving circuit 12 described above, output of the power receiving circuit 12 operates as a voltage source or a current source. In the configurations of the power transmitting circuit 11 and the power receiving circuit 12 shown in FIG. 1, the power supply is a voltage source and the resonator does not have immittance conversion characteristic. Therefore, output of the power receiving circuit 12 operates as a voltage source. The configurations of the power transmitting circuit 11 and the power receiving circuit 12 shown in FIG. 1 are merely an example, and their configurations are not limited thereto. However, the present embodiment is directed to a configuration in which output of the power receiving circuit 12 operates as a voltage source.

FIG. 2 is a schematic circuit diagram showing the configuration of the power receiving device 10 according to embodiment 1. In the present embodiment, an example in which a rectification circuit 13a is used as the power converter 13 will be described. The rectification circuit 13a includes four diodes 131, 132, 133, 134 and two semiconductor switches 135a, 136a. The diode 132 and the semiconductor switch 135a are connected in series, and the diode 134 and the semiconductor switch 136a are connected in series. The semiconductor switches 135a, 136a are electric components each having such characteristics that a switch such as a metal-oxide-semiconductor field-effect transistor (MOS-FET) or an insulated gate bipolar transistor (IGBT), and a diode, are connected in antiparallel, for example. The semiconductor switch 135a is connected in series to the diode 132 in such a direction that current does not flow through the diode 132 when the switch is OFF. Similarly, the semiconductor switch 136a is connected in series to the diode 134 in such a direction that current does not flow through the diode 134 when the switch is OFF. In FIG. 2, the semiconductor switches 135a, 136a are respectively connected in series to the diode 132 and the diode 134 which are lower arms on the negative side of the rectification circuit 13a. However, the semiconductor switches 135a, 136a may be respectively connected in series to the diode 131 and the diode 133 which are upper arms on the positive side.

The LC filter 14 is composed of a DC inductor 141 and a DC capacitor 142, and serves to attenuate AC components contained in the output voltage and current from the rectification circuit 13a.

The load 15 is a motor that consumes power, a battery for storing power, or the like.

Voltage detection means 16 detects output voltage V2 of the power receiving circuit 12 (input voltage to the rectification circuit 13a).

The control device 17 generates drive signals for performing ON/OFF control for the semiconductor switches 135a, 136a of the rectification circuit 13a on the basis of information of the voltage V2 detected by the voltage detection means 16.

In the power receiving device 10 according to the present embodiment, depending on the ON/OFF states of the semiconductor switches 135a, 136a, output of the power receiving circuit 12 is made into an open-circuit state so that supply of power from the power receiving circuit 12 to the load 15 is interrupted. As described above, in the configurations of the power transmitting circuit 11 and the power receiving circuit 12 in the present embodiment, output of the power receiving circuit 12 operates as a voltage source. Therefore, when output of the power receiving circuit 12 is in an open-circuit state, the impedance as seen from the AC power supply 5 has a significantly great value. As a result, output power of the AC power supply 5 is reduced.

Hereinafter, the ON/OFF states of the semiconductor switches 135a, 136a and circuit operation will be described.

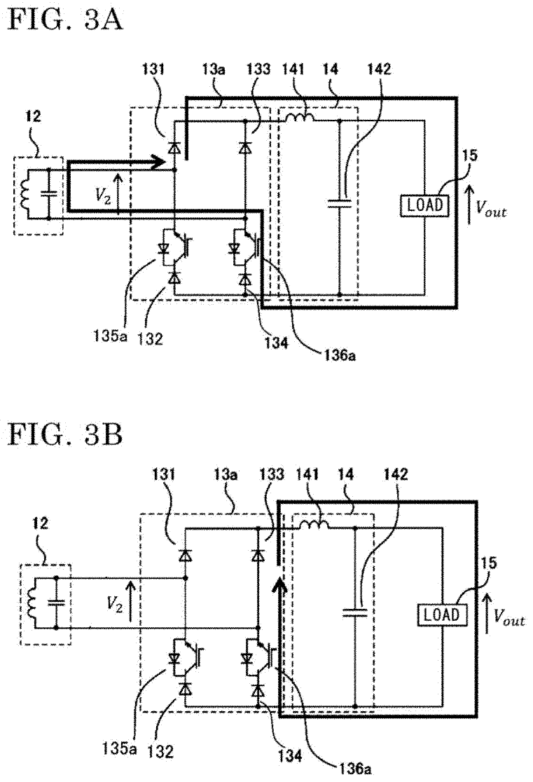

FIG. 3A and FIG. 3B illustrate circuit operation of the power receiving device 10 in a steady state when the semiconductor switch 135a is OFF and the semiconductor switch 136a is ON. Arrows in the drawings indicate current routes.

FIG. 3A shows circuit operation in a case where output voltage V2 of the power receiving circuit 12 is positive, and this operation is operation during a power transfer period in which power is transferred from the power receiving circuit 12 to the load. In the case where the output voltage V2 of the power receiving circuit 12 is positive, the diode 131, the diode 134, and the semiconductor switch 136a conduct current so that power is transferred from the power receiving circuit 12 to the load 15. At this time, output voltage of the rectification circuit 13a is equal to the input voltage V2. At the DC inductor 141 of the LC filter 14, a potential difference between load voltage Vout and the output voltage of the rectification circuit 13a is applied. Load current increases/decreases in accordance with the potential difference and the inductance value of the DC inductor 141.

FIG. 3B shows circuit operation in a case where the output voltage V2 of the power receiving circuit 12 is negative, and this operation is operation during a non-power-transfer period in which supply of power from the power receiving circuit 12 is interrupted. In the case where the output voltage V2 of the power receiving circuit 12 is negative, the diode 133, the diode 134, and the semiconductor switch 136a conduct current and power transfer from the power receiving circuit 12 to the load 15 is stopped. At this time, output voltage of the rectification circuit 13a is zero. Current supplied to the load 15 is from energy stored in the DC inductor 141, and the load current decreases at a slope determined by the load voltage Vout and the inductance value of the DC inductor 141.

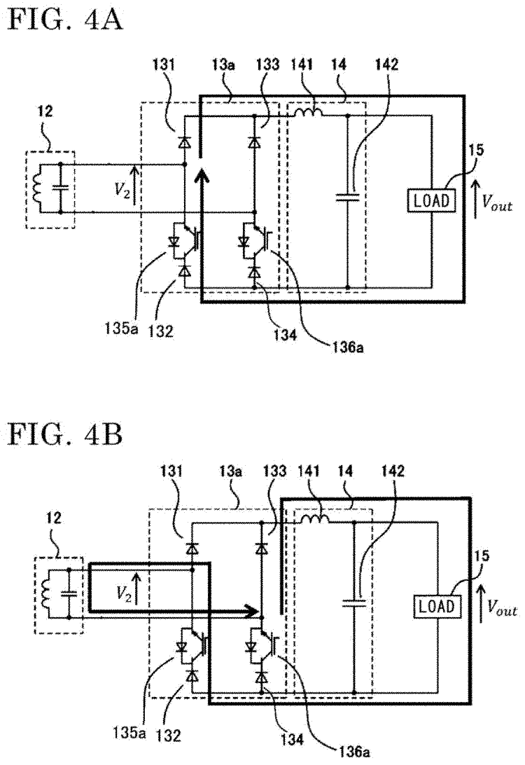

FIG. 4A and FIG. 4B illustrate circuit operation of the power receiving device 10 in a steady state when the semiconductor switch 135a is ON and the semiconductor switch 136a is OFF. Arrows in the drawings indicate current routes.

FIG. 4A shows circuit operation in a case where the output voltage V2 of the power receiving circuit 12 is positive, and this operation is operation during a non-power-transfer period in which supply of power from the power receiving circuit 12 is interrupted. In the case where the output voltage V2 of the power receiving circuit 12 is positive, the diode 131, the diode 132, and the semiconductor switch 135a conduct current and power transfer from the power receiving circuit 12 to the load 15 is stopped. At this time, output voltage of the rectification circuit 13a is zero. Current supplied to the load 15 is from energy stored in the DC inductor 141, and the load current decreases at a slope determined by the load voltage Vout and the inductance value of the DC inductor 141.

FIG. 4B shows circuit operation in a case where the output voltage V2 of the power receiving circuit 12 is negative, and this operation is operation during a power transfer period in which power is transferred from the power receiving circuit 12 to the load. In the case where the output voltage V2 of the power receiving circuit 12 is negative, the diode 133, the diode 132, and the semiconductor switch 135a conduct current so that power is transferred from the power receiving circuit 12 to the load 15. Therefore, the output voltage of the rectification circuit 13a is equal to the input voltage V2. At this time, at the DC inductor 141, a potential difference between the load voltage Vout and output voltage of the rectification circuit 13a is applied, and the load current increases/decreases in accordance with the potential difference and the inductance value of the DC inductor 141.

In a case where the semiconductor switches 135a, 136a are both ON, the rectification circuit 13a works as a full-bridge diode rectification circuit. That is, when the output voltage V2 of the power receiving circuit 12 is positive, the circuit operation in FIG. 3A is performed, and when the output voltage V2 of the power receiving circuit 12 is negative, the circuit operation in FIG. 4B is performed. Thus, power is transferred from the power receiving circuit 12 to the load 15 without depending on the polarity of the output voltage V2 of the power receiving circuit 12. Therefore, this period is constantly a power transfer period.

On the other hand, in a case where the semiconductor switches 135a, 136a are both OFF, there is no route through which power is transferred from the power receiving circuit 12 to the load 15. Also, there is no circulation route for energy stored in the DC inductor 141. Thus, overvoltage occurs at the semiconductor switch 135a or 136a. Occurrence of overvoltage might lead to breakage of the semiconductor switch. Therefore, it is necessary to generate drive signals so that the semiconductor switches 135a, 136a are not both turned off. Accordingly, in a case of switching on and off the semiconductor switches 135a, 136a complementarily with each other, it is desirable to provide an overlap time in which both switches are turned on at the same time.

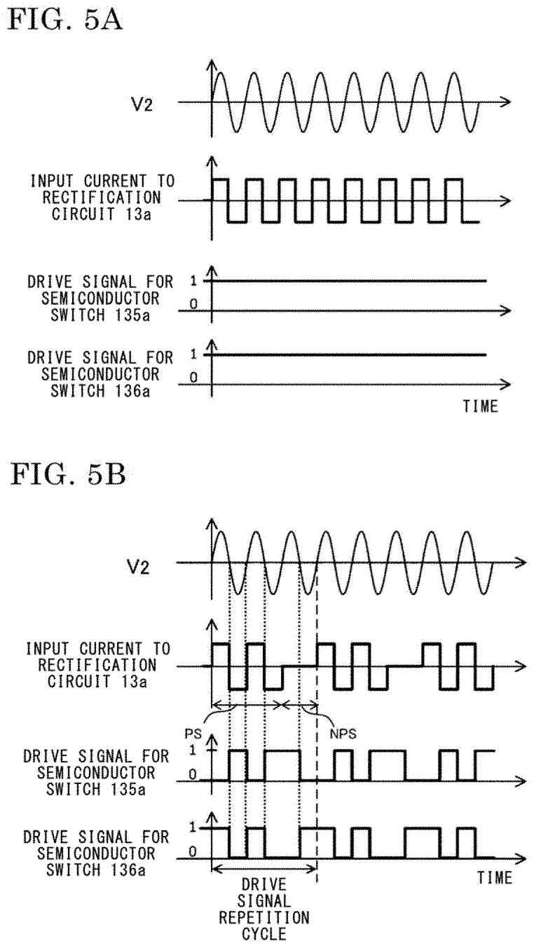

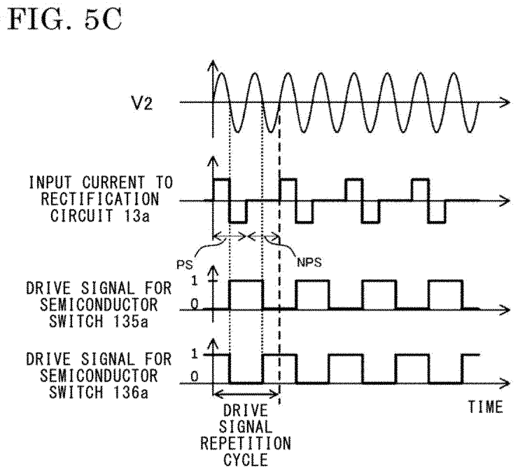

FIGS. 5A, 5B, 50 illustrate a basic control method for power control in the power receiving device 10 according to embodiment 1, and schematically show waveforms of signals. From the upper stage in each figure, schematic waveforms of output voltage V2 of the power receiving circuit 12, input current to the rectification circuit 13a, and drive signals for the semiconductor switches 135a, 136a, are shown. It is noted that each drive signal indicates ON when the waveform has a value of 1, and indicates OFF when the waveform has a value of 0.

FIG. 5A shows signal waveforms when output power from the power receiving device 10 is maximized. The output voltage V2 of the power receiving circuit 12 and the input current have a sine waveform and a rectangular waveform, respectively, and the two semiconductor switches 135a, 136a are constantly in ON states. That is, FIG. 5A shows a state in which power transfer is continuing.

FIG. 5B shows signal waveforms when output power from the power receiving device 10 is set to be smaller than that in FIG. 5A. ON/OFF switching of the semiconductor switches 135a, 136a is performed at a zero cross part or in the vicinity of the zero cross part of the output voltage V2 of the power receiving circuit 12 detected by the voltage detection means 16, as indicated by dotted-line positions in FIG. 5B. That is, switching between a power transfer period PS and a non-power-transfer period NPS is performed at a zero cross part or in the vicinity of the zero cross part of the output voltage V2 of the power receiving circuit 12. In addition, the power control is performed by controlling a time ratio between a total power transfer period and a total non-power-transfer period in a predetermined period. The predetermined period is set in advance to a time length that is an integer multiple of a half cycle of the output voltage V2 of the power receiving circuit 12, and can be changed in accordance with required power. In FIG. 5B, the repetition cycle of the drive signals for the semiconductor switches 135a, 136a is set to be equal to a three-cycle period of the output voltage V2 of the power receiving circuit 12, a two-cycle period of the output voltage V2 of the power receiving circuit 12 is set to be a power transfer period PS, and the remaining one-cycle period is set to be a non-power-transfer period NPS. The average value of the output voltage of the rectification circuit 13a in FIG. 5B is ⅔ of the average value of the output voltage of the rectification circuit 13a in FIG. 5A. Therefore, if the load 15 is a resistance load, the output power in FIG. 5B is 4/9 of the output power in the signal waveform shown in FIG. 5A.

Here, the zero cross part or the vicinity of the zero cross part of the output voltage V2 is a time when the output voltage V2 of the power receiving circuit 12 detected by the voltage detection means 16 has a voltage value sufficiently smaller than its maximum value, and is a time when the absolute value of the output voltage V2 is approximately 20% or less of the maximum value.

FIG. 5C shows signal waveforms when output power from the power receiving device 10 is set to be smaller than those in FIG. 5A and FIG. 5B. In FIG. 5C, the repetition cycle of the drive signals for the semiconductor switches 135a, 136a is set to be equal to a two-cycle period of the output voltage V2 of the power receiving circuit 12, a one-cycle period of the output voltage V2 of the power receiving circuit 12 is set to be a power transfer period PS, and the remaining one-cycle period is set to be a non-power-transfer period NPS. The average value of the output voltage of the rectification circuit 13a in FIG. 5C is ½ of the average value of the output voltage of the rectification circuit 13a in FIG. 5A. Therefore, if the load 15 is a resistance load, the output power in FIG. 5C is ¼ of the output power in the signal waveform shown in FIG. 5A.

As described above, by adjusting the ratio between the power transfer period and the non-power-transfer period in the predetermined period set in advance, output voltage of the rectification circuit 13a can be controlled, and as a result, output power can be controlled. In addition, since ON/OFF switching operations of all the semiconductor switches are performed at a zero cross timing or in the vicinity of the zero cross timing of the output voltage V2 of the power receiving circuit 12, switching loss represented by a product of voltage and current of the semiconductor switch can be reduced to a small value.

In FIGS. 5A, 5B, 5C, the example in which the semiconductor switches 135a, 136a are switched on and off complementarily with each other, has been shown. However, even in a case where the two semiconductor switches are both turned on in the power transfer period, circuit operation is performed in the same manner.

Next, methods for obtaining the same output power from the power receiving device 10 by different power controls will be described.

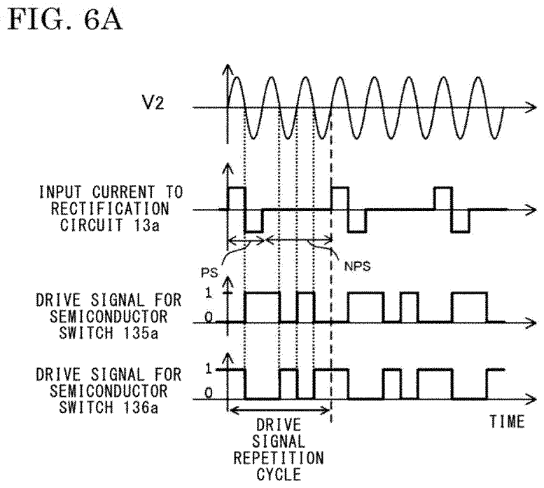

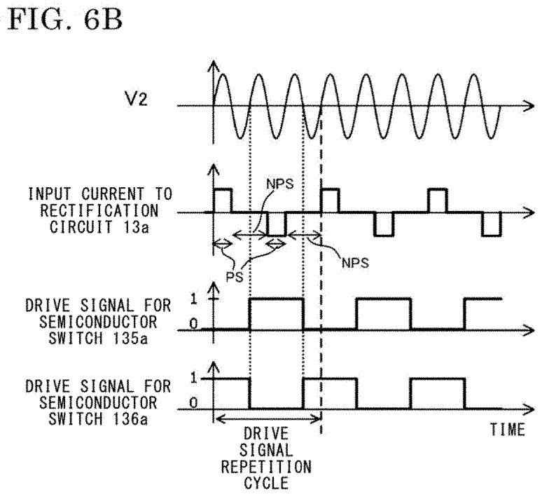

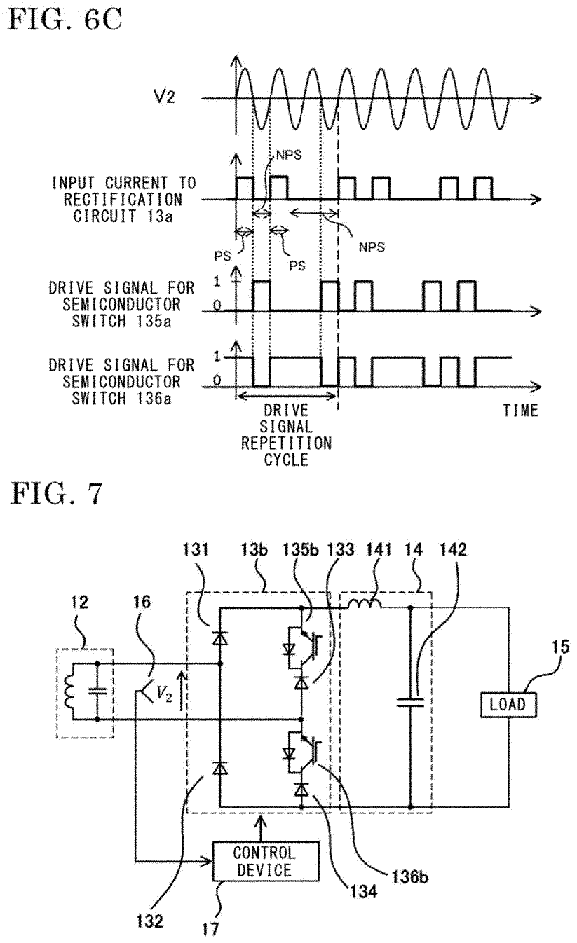

FIGS. 6A, 6B, 6C illustrate control methods by different power controls in the power receiving device 10 according to embodiment 1. In FIGS. 6A, 6B, 6C, as in FIGS. 5A, 5B, 5C, from the upper stage in each figure, schematic waveforms of input voltage V2 to the rectification circuit 13a, input current to the rectification circuit 13a, and the drive signals for the semiconductor switches 135a, 136a, are shown. In three examples shown in FIGS. 6A, 6B, 6C, the repetition cycle of the drive signals is set to be equal to a three-cycle period of the output voltage V2 of the power receiving circuit 12, a power transfer period is provided in only one cycle of the three cycles of the output voltage V2 of the power receiving circuit 12, and the drive signals for the semiconductor switches 135a, 136a are set so that the average value of the output voltage becomes ⅓ of the value in the maximum state (a state in which the two switches are constantly ON).

In the signal waveforms in FIG. 6A, a power transfer period PS is set using, as one unit, one cycle of the frequency of the output voltage V2 of the power receiving circuit 12, as in the examples shown in FIGS. 5A, 5B, 5C. Where the repetition cycle of the drive signals is an N-cycle period (here, N=3) and the power transfer period PS is an M-cycle period (here, M=1), in a case of setting the average value of the output power to M/N of the value in the maximum state, a pattern in which the power transfer period PS for M cycles and the non-power-transfer period NPS for (N−M) cycles (here, N−M=2) are repeated, is set.

In the signal waveforms in FIG. 6B, unlike the signal waveforms shown in FIG. 6A, a power transfer period PS is set using, as one unit, a half cycle of the frequency of the output voltage V2 of the power receiving circuit 12. Then, the power transfer period PS for this one unit is provided intermittently, so that a total power transfer period is equal to a one-cycle period of the output voltage V2 of the power receiving circuit 12, in the repetition period of the drive signals.

FIG. 6C shows signal waveforms in an example in which a power transfer period and a non-power-transfer period are set in accordance with the polarity of the output voltage V2 of the power receiving circuit 12. That is, in FIG. 6C, first two periods in which the output voltage V2 of the power receiving circuit 12 is positive are set as power transfer periods PS, and periods in which the output voltage V2 is negative are always set as non-power-transfer periods NPS. Then, as in FIG. 6B, the power transfer period PS is set using, as one unit, a half cycle of the frequency of the output voltage V2 of the power receiving circuit 12, and the power transfer period PS for this one unit is intermittently provided, so that a total power transfer period is equal to a one-cycle period of the output voltage V2 of the power receiving circuit 12, in the repetition cycle of the drive signals.

In each of FIGS. 6A, 6B, 6C, the average value of the output voltage is set to be ⅓ of the value in the maximum state (a state in which the two switches are constantly ON), but this condition is realized using different waveforms for the drive signals for the semiconductor switches 135a, 136a. Depending on difference in the waveforms for the drive signals, the magnitude of ripple current contained in output current of the rectification circuit differs. For example, in the waveforms of the drive signals in FIG. 6A, the non-power-transfer period is a two-cycle period of the output voltage V2 of the power receiving circuit 12, whereas in the waveforms of the drive signals in FIG. 6B, two non-power-transfer periods are provided in the repetition cycle of the drive signals, and each one of the non-power-transfer periods is a one-cycle period of the output voltage V2 of the power receiving circuit 12. If the length of the non-power-transfer period is shortened, ripple current in the input current to the rectification circuit 13a is reduced. Therefore, ripple current is smaller in FIG. 6B than in the case of the waveforms of the drive signals in FIG. 6A. The ripple current which is an AC component eventually needs to be attenuated by the LC filter 14. Therefore, if the ripple current is small, the LC filter 14 can be downsized.

Similarly, in the waveforms of the drive signals in FIG. 6C, two non-power-transfer periods are provided in the repetition cycle of the drive signals, and each of the non-power-transfer periods is shorter than the length of the non-power-transfer period in FIG. 6A. Therefore, ripple current can be made smaller than in the case of the waveforms of the drive signals in FIG. 6A.

As is found from the waveforms of the drive signals shown in FIGS. 5A, 5B, 5C and FIGS. 6A, 6B, 6C, power control can be performed by changing the waveforms of the drive signals for the semiconductor switches 135a, 136a, and switching loss can be reduced by performing ON/OFF switching operations of the semiconductor switches 135a, 136a at a zero cross timing or in the vicinity of the zero cross timing of the output voltage V2 of the power receiving circuit 12.

As described above, the power receiving device 10 of the wireless power transfer system according to embodiment 1 at least includes: the power receiving circuit 12 for receiving power from the power transmitting circuit 11; the voltage detection means 16 for detecting output voltage V2 of the power receiving circuit 12; the power converter 13 (rectification circuit 13a) which has the semiconductor switches 135a, 136a and converts AC power received by the power receiving circuit 12 to DC power; and the control device for controlling the semiconductor switches 135a, 136a on the basis of the output voltage V2 of the power receiving circuit 12 detected by the voltage detection means 16, wherein current conduction and interruption with the power receiving circuit 12 are switched through operations of the semiconductor switches 135a, 136a. Thus, in the resonator configuration operating as a voltage source, an interruption state can be made by opening the circuit, instead of short-circuit, between the power receiving circuit and the power converter. As a result, there is no risk of breakage of elements composing the power converter due to overcurrent, and the like.

In addition, in a predetermined period set in advance, a ratio between a power transfer period in which the power converter 13 and the power receiving circuit 12 are conductive with each other and a non-power-transfer period in which conduction between the power converter 13 and the power receiving circuit 12 is interrupted, is adjusted, whereby output voltage of the power converter 13 is controlled, and as a result, output power can be controlled. In addition, ON/OFF switching operations of all the semiconductor switches are performed at a zero cross timing or in the vicinity of the zero cross timing of the output voltage V2 of the power receiving circuit 12, whereby switching loss can be reduced and thus power control can be performed with high efficiency.

### Embodiment 2

Hereinafter, a power receiving device in a wireless power transfer system according to embodiment 2 will be described. The power receiving device according to embodiment 2 is also applied to the wireless power transfer system shown in FIG. 1 in embodiment 1.

FIG. 7 is a schematic circuit diagram showing the configuration of the power receiving device according to embodiment 2. Parts that are the same as or correspond to those in FIG. 2 are denoted by the same reference characters, and the description thereof is omitted. In embodiment 2, two semiconductor switches 135b, 136b in a rectification circuit 13b are respectively connected in series to the diode 133 and the diode 134, unlike embodiment 1. Arrangement of the semiconductor switches 135b, 136b in FIG. 7 is merely an example, and the semiconductor switches may be connected in series to the diode 131 and the diode 132. That is, the semiconductor switches may be connected in series to the diodes at one of two legs on the left and right sides composing the rectification circuit 13b.

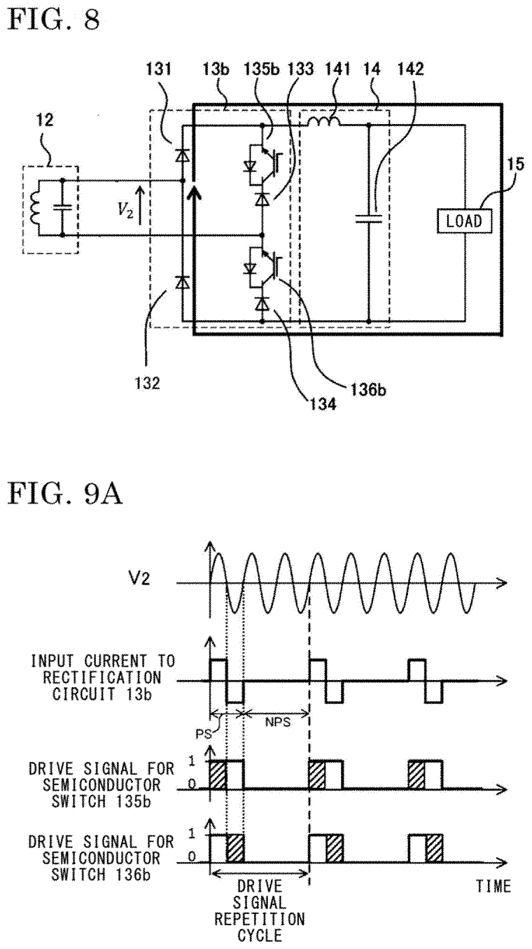

Operation difference from embodiment 1 is that the circulation route of energy stored in the DC inductor 141 in a non-power-transfer period is not influenced by the states of the semiconductor switches 135b, 136b. FIG. 8 shows one of current routes in a non-power-transfer period in the configuration shown in FIG. 7. Energy stored in the DC inductor 141 can circulate through the load 15, the diode 132, and the diode 131, and no semiconductor switches are present on the circulation route. On the other hand, in the non-power-transfer period in embodiment 1, as shown in FIG. 3B and FIG. 4A, there is a semiconductor switch on the circulation route of energy of the DC inductor 141. When energy stored in the DC inductor 141 circulates, if any semiconductor switch is damaged or erroneously operates, the circulation route is interrupted, so that overvoltage occurs in the circuit due to the energy stored in the DC inductor 141, and thus the entire device might be disabled. However, in the configuration in embodiment 2, there are no semiconductor switches on the circulation route of energy stored in the DC inductor 141, and therefore the circulation route is not influenced by the states of the semiconductor switches 135b, 136b.

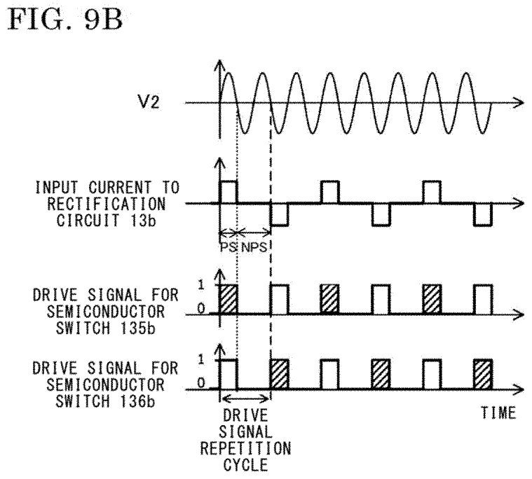

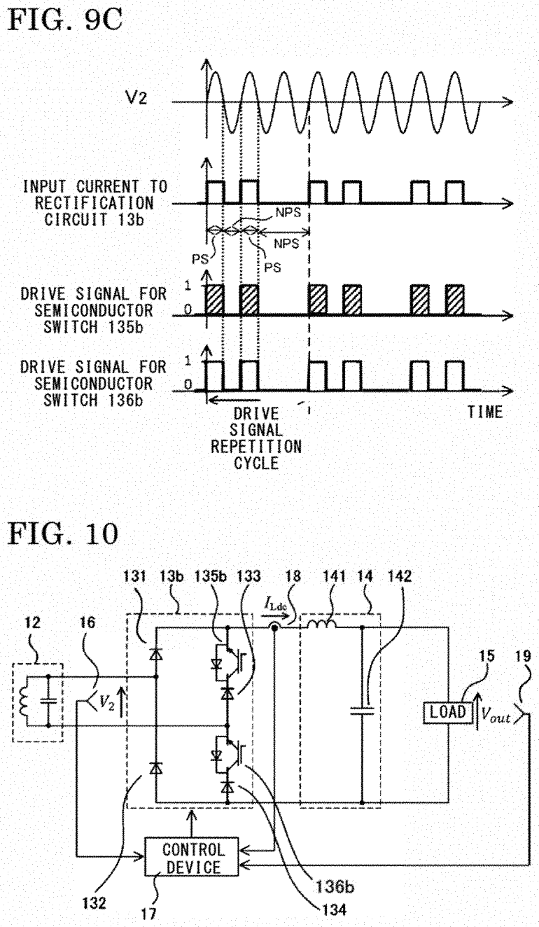

FIGS. 9A, 9B, 9C illustrate examples of a control method for power control in the power receiving device according to embodiment 2, and schematically show waveforms of signals in the power receiving device. From the upper stage in each figure, schematic waveforms of output voltage V2 of the power receiving circuit 12, input current to the rectification circuit 13b, and drive signals for the semiconductor switches 135b, 136b, are shown. In all the three examples shown in FIGS. 9A, 9B, 9C, the drive signals for the semiconductor switches 135b, 136b are set so that the average value of the output voltage from the power receiving device becomes ⅓ of the value in the maximum state (a state in which the two switches are constantly ON).

FIG. 9A shows signal waveforms in a power control method in which the semiconductor switches are driven using, as one unit, one cycle of the output voltage V2 of the power receiving circuit 12. FIG. 9B shows signal waveforms in a power control method in which the semiconductor switches are driven using, as one unit, a half cycle of the output voltage V2 of the power receiving circuit 12. FIG. 9C shows signal waveforms in a power control method in which a power transfer period PS and a non-power-transfer period NPS are set in accordance with the polarity of the output voltage V2 of the power receiving circuit 12.

As is found from FIGS. 9A, 9B, 9C, in embodiment 2, when the two semiconductor switches 135b, 136b are turned on, the power transfer period PS can be provided, and when the two semiconductor switches 135b, 136b are turned off, the non-power-transfer period NPS can be provided. Therefore, it is possible to operate the two semiconductor switches 135b, 136b by the same drive signal.

In the signal waveforms in FIG. 9B, a half cycle of the output voltage V2 of the power receiving circuit 12 is used as one unit of the power transfer period PS, and the repetition cycle of the drive signals is equal to a 1.5-cycle period of the output voltage V2 of the power receiving circuit 12, i.e., half the periods in FIG. 9A and FIG. 9C.

In the power transfer period PS, only one of the two semiconductor switches is used on the current route, and therefore the state of the other semiconductor switch may be either ON or OFF. For example, in FIG. 7, even in a case where the semiconductor switches 135b, 136b are both ON, when the output voltage V2 of the power receiving circuit 12 is positive, the current route is formed through the semiconductor switch 136b side, and when the output voltage V2 of the power receiving circuit 12 is negative, the current route is formed through the semiconductor switch 135b side. Therefore, in the drive signals for the semiconductor switches 135b, 136b in FIGS. 9A, 9B, 9C, a period in which the drive signal is indicated as ON (signal value is 1) and which is indicated by a hatched area is a period in which the signal state may be either ON or OFF.

In FIG. 9C, the drive signal for the semiconductor switch 135b is switched between ON and OFF. However, the circuit operation is the same even if the drive signal for the semiconductor switch 135b is constantly set to OFF.

As described above, the power receiving device in embodiment 2 provides the same effects as in embodiment 1. Further, in embodiment 2, the semiconductor switches 135b, 136b are respectively connected in series to the diodes at one of the two legs on the left and right sides composing the rectification circuit 13b of the power converter 13. Therefore, a non-power-transfer period can be provided, with the two semiconductor switches 135b, 136b turned off at the same time. Thus, it is possible to prevent occurrence of excess voltage due to the states of the semiconductor switches on the circulation route of energy stored in the DC inductor 141 during the non-power-transfer period. In addition, the two semiconductor switches 135b, 136b can be controlled by one drive signal, and therefore the control device can be simplified as compared to embodiment 1.

### Embodiment 3

Hereinafter, a power receiving device of a wireless power transfer system according to embodiment 3 will be described. The power receiving device according to embodiment 3 is also applied to the wireless power transfer system shown in FIG. 1 in embodiment 1.

FIG. 10 is a schematic circuit diagram showing the configuration of the power receiving device according to embodiment 3. Parts that are the same as or correspond to those in FIG. 7 are denoted by the same reference characters, and the description thereof is omitted. The power receiving device according to embodiment 3 further includes current detection means 18 for detecting current ILdc flowing through the DC inductor 141, and voltage detection means 19 for detecting voltage Vout of the load 15. Information of current and voltage detected by the current detection means 18 and the voltage detection means 19 is inputted to the control device 17. In embodiments 1 and 2, the control device 17 sets an output power command value Pout* so that output from the power receiving device has predetermined output power set in advance, and generates drive signals for the semiconductor switches, to control the semiconductor switches, thus performing power control. In embodiment 3, the control device 17 divides the output power command value Pout* by load voltage Vout detected by the voltage detection means 19, to calculate a current command value ILdc* for the DC inductor 141, and then performs current control to control the semiconductor switches so that current ILdc of the DC inductor 141 detected by the current detection means 18 becomes the current command value ILdc*, thereby controlling output power.

Hereinafter, a method for performing output power control by controlling current of the DC inductor 141 using the semiconductor switches 135b, 136b will be described.

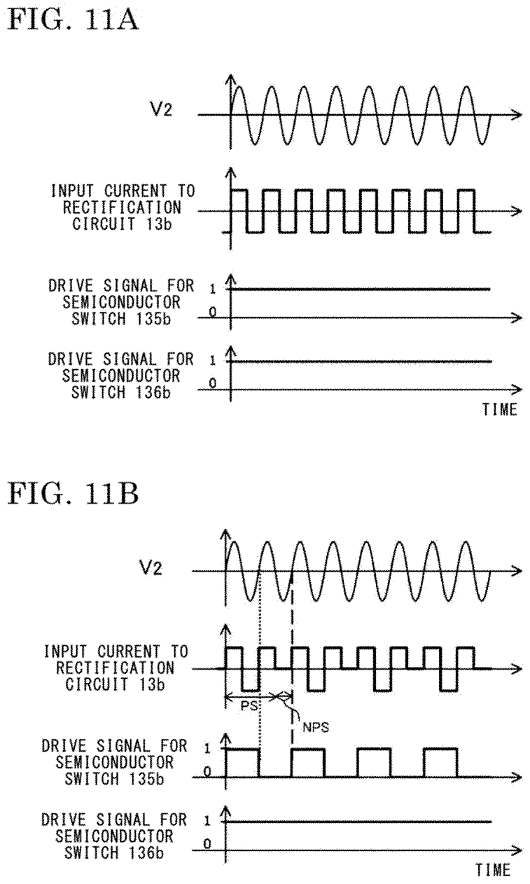

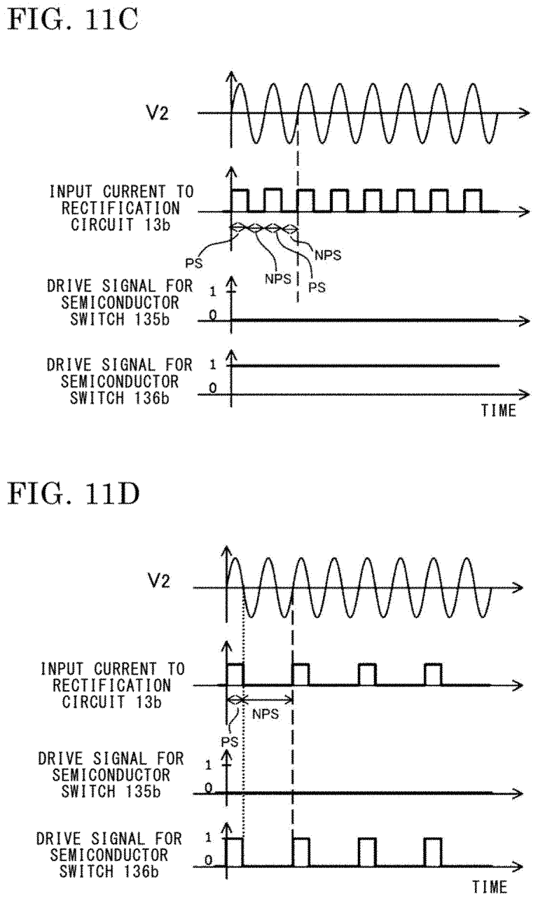

FIGS. 11A, 11B, 11C, 11D schematically show waveforms of signals in the power receiving device according to embodiment 3, and illustrate drive signal patterns used in inductor current control. In the present embodiment, five drive signal patterns are set, i.e., drive signal patterns for controlling the semiconductor switches 135b, 136b so as to obtain the following four voltages with respect to the maximum voltage of the average value of the output voltage of the rectification circuit 13b, and in addition, a drive signal pattern that makes a non-power-transfer state.

Drive signal pattern I: a pattern in which the average value of the output voltage is maximum voltage

Drive signal pattern II: a pattern in which the average value of the output voltage is ¾ of maximum voltage

Drive signal pattern III: a pattern in which the average value of the output voltage is ½ of maximum voltage

Drive signal pattern IV: a pattern in which the average value of the output voltage is ¼ of maximum voltage

Drive signal pattern V: a pattern that makes a non-power-transfer state

The control device 17 has and executes these drive signal patterns.

FIG. 11A shows the drive signal pattern I, in which a power transfer state is continuing. FIG. 11B shows the drive signal pattern II, in which, focusing on two cycles of the output voltage V2 of the power receiving circuit 12, a 1.5-cycle period corresponds to a power transfer period PS, a half-cycle period corresponds to a non-power-transfer period NPS, and the average value of the output voltage of the rectification circuit 13b is ¾ of maximum voltage. FIG. 11C shows the drive signal pattern III, in which, focusing on two cycles of the output voltage V2 of the power receiving circuit 12, a power transfer period PS for a half cycle and a non-power-transfer period NPS for a half cycle are repeated, and the average value of the output voltage of the rectification circuit 13b is ½ of maximum voltage. FIG. 11D shows the drive signal pattern IV, in which, focusing on two cycles of the output voltage V2 of the power receiving circuit 12, a half-cycle period corresponds to a power transfer period PS, a 1.5-cycle period corresponds to a non-power-transfer period NPS, and the average value of the output voltage of the rectification circuit 13b is ¼ of maximum voltage. The drive signal pattern V (not shown) corresponds to a non-power-transfer state in which the semiconductor switches 135b, 136b are both OFF (values of drive signals are 0).

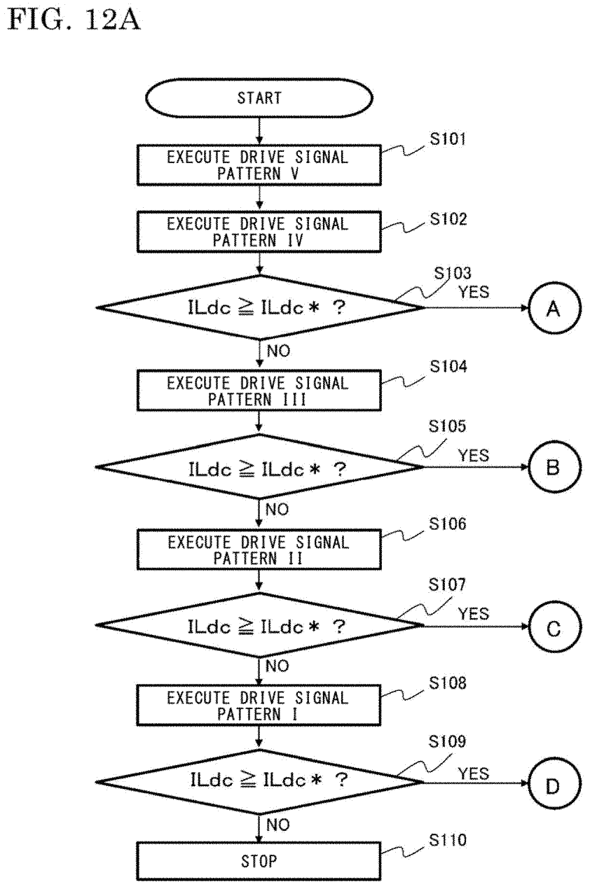

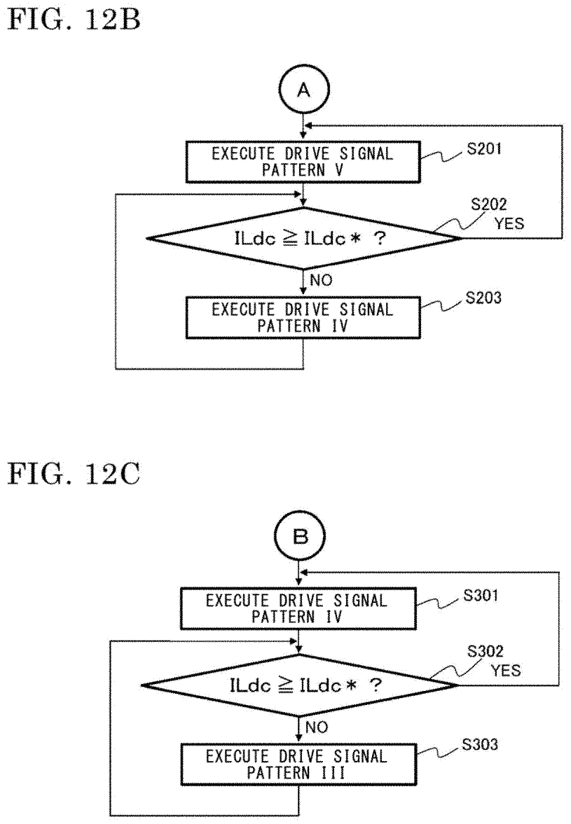

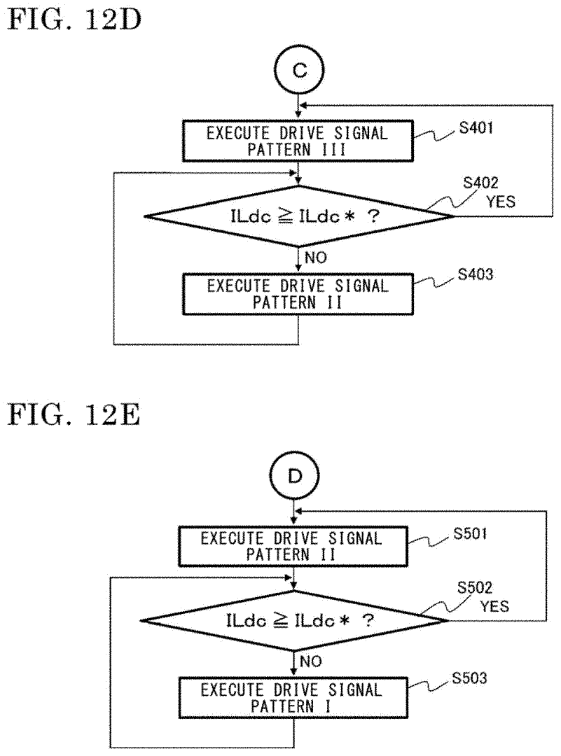

Next, a method for performing output power control by controlling current of the DC inductor 141 using the five drive signal patterns will be described in accordance with flowcharts in FIG. 12A to FIG. 12E.

In FIG. 12A, first, the initial state in step S101 is a non-power-transfer state, and corresponds to a state in which the drive signal pattern V is being executed. When power transfer is started, the control device 17 divides a set output power command value Pout* by load voltage Vout detected by the voltage detection means 19, to calculate a current command value ILdc* for the DC inductor 141. In addition, current ILdc of the DC inductor 141 detected by the current detection means 18 is inputted to the control device 17.

In step S102 in which power transfer is started, when the drive signal pattern IV is executed, the current ILdc of the DC inductor 141 increases. In step S103, whether or not the detected current ILdc of the DC inductor 141 has become the current command value ILdc* or greater is determined. If the detected current ILdc has become the current command value ILdc* or greater (YES), the process proceeds to step S201 shown in the flowchart in FIG. 12B. If the detected current ILdc of the DC inductor 141 has not reached the current command value ILdc* in step S103 (NO), the drive signal pattern III is executed in step S104.

In step S104, when the drive signal pattern III is executed, the current ILdc of the DC inductor 141 further increases. In step S105, whether or not the detected current ILdc of the DC inductor 141 has become the current command value ILdc* or greater is determined. If the detected current ILdc has become the current command value ILdc* or greater (YES), the process proceeds to step S301 shown in the flowchart in FIG. 12C. If the detected current ILdc of the DC inductor 141 has not reached the current command value ILdc* in step S105 (NO), the drive signal pattern II is executed in step S106.

In step S106, when the drive signal pattern II is executed, the current ILdc of the DC inductor 141 further increases. In step S107, whether or not the detected current ILdc of the DC inductor 141 has become the current command value ILdc* or greater is determined. If the detected current ILdc has become the current command value ILdc* or greater (YES), the process proceeds to step S401 shown in the flowchart in FIG. 12D. If the detected current ILdc of the DC inductor 141 has not reached the current command value ILdc* in step S107 (NO), the drive signal pattern I is executed in step S108.

In step S108, when the drive signal pattern I is executed, the current ILdc of the DC inductor 141 further increases. In step S109, whether or not the detected current ILdc of the DC inductor 141 has become the current command value ILdc* or greater is determined. If the detected current ILdc has become the current command value ILdc* or greater (YES), the process proceeds to step S501 shown in the flowchart in FIG. 12E. If the detected current ILdc of the DC inductor 141 has not reached the current command value ILdc* in step S109 (NO), for example, there might be a problem with setting of the current command value ILdc*. Therefore, in step S110, it is determined that control is impossible, and power transfer is stopped.

In steps S103, S105, S107, S109, determination for whether the detected current ILdc of the DC inductor 141 has not reached the current command value ILdc* or has become the current command value ILdc* or greater, is performed as follows. For example, if the detected current ILdc of the DC inductor 141 has not varied for a certain period and has not reached the current command value ILdc*, it is determined that the detected current ILdc has not reached the current command value ILdc*. Alternatively, if the detected current ILdc has not reached the current command value ILdc* even after a time three times as long as the repetition period of the drive signals has elapsed, it is determined that the detected current ILdc has not reached the current command value ILdc*. Here, the time to elapse may be set as appropriate. In this way, the determination is performed on the basis of the saturation condition or transition of the detected current ILdc of the DC inductor 141.

In step S103, if the detected current ILdc of the DC inductor 141 has become the current command value ILdc* or greater, the process proceeds to step S201 in FIG. 12B, to execute the drive signal pattern V. That is, a non-power-transfer state is made. Thus, the current ILdc of the DC inductor 141 decreases. Then, the process proceeds to step S202, to determine whether or not the current ILdc of the DC inductor 141 is the current command value ILdc* or greater. If the current ILdc of the DC inductor 141 continues to be the current command value ILdc* or greater (YES), the non-power-transfer state in step S201 continues. If the current ILdc of the DC inductor 141 has become smaller than the current command value ILdc* in step S202, the drive signal pattern IV is executed in step S203, so that the current ILdc of the DC inductor 141 increases.

Subsequently, until a command for stopping power transfer is issued, the drive signal pattern V and the drive signal pattern IV are executed, whereby the current ILdc of the DC inductor 141 is controlled so as to approach the current command value ILdc*.

Similarly, if the detected current ILdc of the DC inductor 141 has become the current command value ILdc* or greater in step S105, the process proceeds to step S301 in FIG. 12C, to execute the drive signal pattern IV. Thus, the current ILdc of the DC inductor 141 decreases. Then, the process proceeds to step S302, to determine whether or not the current ILdc of the DC inductor 141 is the current command value ILdc* or greater. If the current ILdc of the DC inductor 141 continues to be the current command value ILdc* or greater (YES), execution of the drive signal pattern IV in step S301 continues. If the current ILdc of the DC inductor 141 has become smaller than the current command value ILdc* in step S302, the drive signal pattern III is executed in step S303, so that the current ILdc of the DC inductor 141 increases.

Subsequently, until a command for stopping power transfer is issued, the drive signal pattern IV and the drive signal pattern III are executed, whereby the current ILdc of the DC inductor 141 is controlled so as to approach the current command value ILdc*.

Similarly, in step S107, if the detected current ILdc of the DC inductor 141 has become the current command value ILdc* or greater, the process proceeds to step S401 in FIG. 12D, to execute the drive signal pattern III. Thus, the current ILdc of the DC inductor 141 decreases. Then, the process proceeds to step S402, to determine whether or not the current ILdc of the DC inductor 141 is the current command value ILdc* or greater. If the current ILdc of the DC inductor 141 continues to be the current command value ILdc* or greater (YES), execution of the drive signal pattern III in step S401 continues. If the current ILdc of the DC inductor 141 has become smaller than the current command value ILdc* in step S402, the drive signal pattern II is executed in step S403, so that the current ILdc of the DC inductor 141 increases.

Subsequently, until a command for stopping power transfer is issued, the drive signal pattern III and the drive signal pattern II are executed, whereby the current ILdc of the DC inductor 141 is controlled so as to approach the current command value ILdc*.

Similarly, in step S109, if the detected current ILdc of the DC inductor 141 has become the current command value ILdc* or greater, the process proceeds to step S501 in FIG. 12E, to execute the drive signal pattern II. Thus, the current ILdc of the DC inductor 141 decreases. Then, the process proceeds to step S502, to determine whether or not the current ILdc of the DC inductor 141 is the current command value ILdc* or greater. If the current ILdc of the DC inductor 141 continues to be the current command value ILdc* or greater (YES), execution of the drive signal pattern II in step S501 continues. If the current ILdc of the DC inductor 141 has become smaller than the current command value ILdc* in step S502, the drive signal pattern I is executed in step S503, so that the current ILdc of the DC inductor 141 increases.

Subsequently, until a command for stopping power transfer is issued, the drive signal pattern II and the drive signal pattern I are executed, whereby the current ILdc of the DC inductor 141 is controlled so as to approach the current command value ILdc*.

As described above, the average value of the output voltage of the rectification circuit 13b is increased stepwise, and two drive signal patterns with which the current value can be controlled to be the current command value ILdc* are selected, whereby current control can be controlled at voltage close to the load voltage Vout.

As described above, in step S109, in a case where the current ILdc of the DC inductor 141 does not become the current command value ILdc* or greater even when the drive signal pattern I is executed, in step S110, it is determined that control is impossible, and power transfer is stopped. However, besides a problem with the setting of the current command value ILdc* or the like, there is also a possibility that current control cannot be performed in principle. Therefore, change of a test condition or a circuit constant may be needed.

By applying this current control, voltage applied to the DC inductor 141 and variation of the applied voltage can be minimized, and thus output current ripple of the rectification circuit 13b can be reduced. In addition, in a case of controlling current ripple to be constant, the inductance value needed for the DC inductor 141 can be designed to be smaller when the current control method of embodiment 3 is applied, than when the power receiving device is operated with only the drive signal pattern I that makes maximum voltage and the drive signal pattern V that makes a non-power-transfer state. Thus, size reduction can be achieved.

The drive signal pattern and the control method described above are an example of embodiment 3. Alternatively, the number of drive signal patterns may be more than five or less than five, or the type of the driving method may be changed to a different one, for example. The control device 17 may have at least three drive signal patterns and may control the semiconductor switches so as to reach a preset output power command value Pout* stepwise, using two drive signal patterns in which the ratios between the power transfer period and the non-power-transfer period are close to each other among a plurality of drive signal patterns, on the basis of the current ILdc detected by the current detection means 18.

As described above, the power receiving device according to embodiment 3 provides the same effects as in embodiment 2. Further, the power receiving device includes the current detection means 18 for detecting current ILdc flowing through the DC inductor 141 and the voltage detection means 19 for detecting voltage Vout of the load 15, and output power is controlled using current control to control the semiconductor switches so that the current ILdc of the DC inductor 141 detected by the current detection means 18 becomes the current command value ILdc*. Therefore, by increasing the average value of the output voltage of the rectification circuit 13b stepwise and performing current control at voltage close to the load voltage Vout, voltage applied to the DC inductor 141 and variation of the applied voltage can be reduced, and thus it becomes possible to reduce output current ripple of the rectification circuit 13b.

The above embodiment 3 has shown the example in which the current detection means 18 for detecting current ILdc flowing through the DC inductor 141 and the voltage detection means 19 for detecting voltage Vout of the load 15 are added to FIG. 7 in embodiment 2. However, the current detection means 18 for detecting current ILdc flowing through the DC inductor 141 and the voltage detection means 19 for detecting voltage Vout of the load 15 may be added to FIG. 2 in embodiment 1. Also in embodiment 1, it is possible to prepare drive signal patterns so as to increase the average value of the output voltage of the rectification circuit 13a stepwise, and by increasing the average value of the output voltage of the rectification circuit 13a stepwise and performing current control at voltage close to the load voltage Vout, voltage applied to the DC inductor 141 and variation of the applied voltage can be reduced, and thus it becomes possible to reduce output current ripple of the rectification circuit 13a.

### Embodiment 4

Hereinafter, a power receiving device of a wireless power transfer system according to embodiment 4 will be described. The power receiving device according to embodiment 4 is also applied to the wireless power transfer system shown in FIG. 1 in embodiment 1.

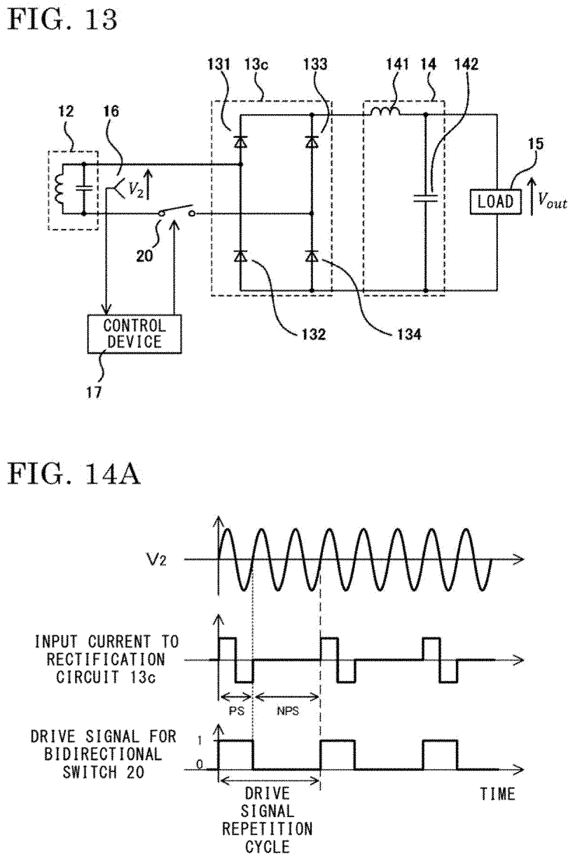

FIG. 13 is a schematic circuit diagram showing the configuration of the power receiving device according to embodiment 4. Parts that are the same as or correspond to those in FIGS. 1, 7, 10 are denoted by the same reference characters, and the description thereof is omitted. In the power receiving device according to embodiment 4, a bidirectional switch 20 is connected between the power receiving circuit 12 and a rectification circuit 13c. In addition, the rectification circuit 13c which is a power converter is composed of only four diodes.

The power receiving device according to embodiment 4 performs output power control using the bidirectional switch 20, so that a power transfer period is provided when the bidirectional switch 20 is ON, and a non-power-transfer period is provided when the bidirectional switch 20 is OFF. In the resonator configuration of the wireless power transfer system operating as a voltage source, when the bidirectional switch 20 is OFF, a part between the power receiving circuit and the power converter is open-circuited, instead of being short-circuited, and thus is interrupted. As a result, there is no risk of breakage of elements (such as diodes) composing the power converter due to overcurrent, and the like. ON/OFF switching of the bidirectional switch 20 is performed at a zero cross timing or in the vicinity of the zero cross timing of the input voltage V2 to the rectification circuit 13c. Thus, switching loss of the bidirectional switch 20 can be reduced as in embodiments 1 to 3 described above.

In addition, output power can be controlled during a period in which the bidirectional switch is ON, and can be controlled irrespective of the polarity of the input voltage V2 to the rectification circuit 13c. Therefore, an effect that a program for the control device can be simplified and the calculation load on the control device can be reduced, is provided. Further, since the rectification circuit 13c is a full-bridge diode rectification circuit, a component formed as a module can be applied, and thus an effect of simplifying circuit mounting is also provided.

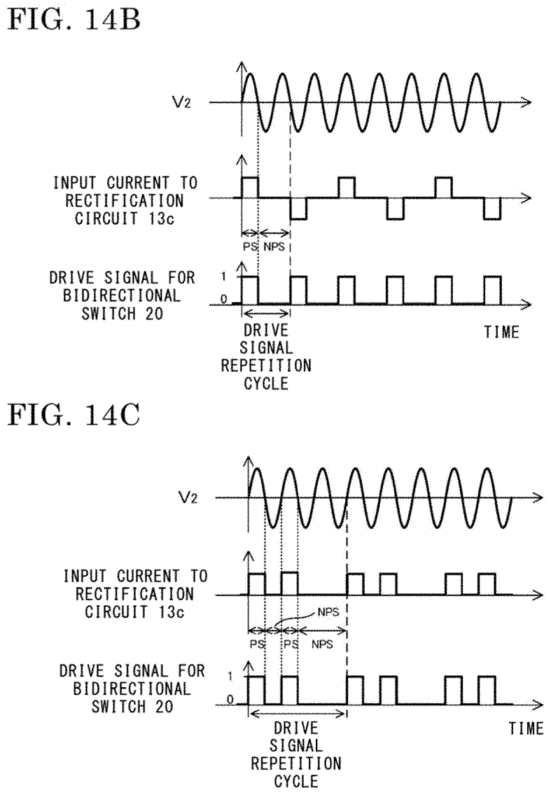

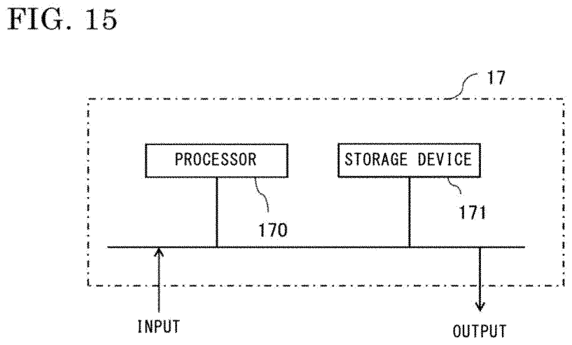

FIGS. 14A, 14B, 14C illustrate control methods by power control in the power receiving device according to embodiment 4. In FIGS. 14A, 14B, 14C, from the upper stage of each figure, schematic waveforms of input voltage V2 to the rectification circuit 13c, input current to the rectification circuit 13c, and the drive signal for the bidirectional switch 20, are shown. In FIG. 14A and FIG. 14C, the repetition period of the drive signal is set to be equal to a three-cycle period of the output voltage V2 of the power receiving circuit 12, a power transfer period is provided in only one cycle of the three cycles of the output voltage V2 of the power receiving circuit 12, and the drive signal for the bidirectional switch 20 is set so that the average value of the output voltage becomes ⅓ of the value in the maximum state (a state in which the bidirectional switch is constantly ON). FIG. 14A and FIG. 14C respectively correspond to the output power controls in FIG. 6A and FIG. 6C in embodiment 1. Thus, also in embodiment 4 using the bidirectional switch 20, the same output power control as in embodiment 1 can be performed.

FIG. 14B shows an example in which a half cycle of the output voltage V2 of the power receiving circuit 12 is used as one unit of the power transfer period PS, and the repetition period of the drive signal is set to be a 1.5-cycle period of the output voltage V2 of the power receiving circuit 12. The drive signal for the bidirectional switch 20 is set so that the average value of the output voltage becomes ⅓ of the value in the maximum state (a state in which the bidirectional switch is constantly ON). FIG. 145 corresponds to the output power control in FIG. 95 in embodiment 2. Thus, also in embodiment 4 using the bidirectional switch 20, the same output power control as in embodiment 1 can be performed.

In FIG. 13, as means for detecting current or voltage, only the voltage detection means 16 for detecting the output voltage V2 of the power receiving circuit 12 is provided. However, voltage detection means for the load 15 and current detection means for the DC inductor 141 included in the LC filter 14 may be added, whereby it is possible to perform power control by inductor current control as shown in embodiment 3.

As described above, in the power receiving device according to the present embodiment 4, the bidirectional switch 20 is provided between the power receiving circuit 12 and the rectification circuit 13c which is a power converter, and is controlled to switch between a power transfer period and a non-power-transfer period. Thus, in addition to the effects in embodiments 1 to 3, the device configuration can be simplified, thus obtaining an effect of size reduction and cost reduction.

The control device 17 is composed of a processor 170 and a storage device 171, as shown in FIG. 15 which shows an example of hardware. Although not shown, the storage device is provided with a volatile storage device such as a random access memory and a nonvolatile auxiliary storage device such as a flash memory. Instead of a flash memory, an auxiliary storage device of a hard disk may be provided. The processor 170 executes a program inputted from the storage device 171. In this case, the program is inputted from the auxiliary storage device to the processor 170 via the volatile storage device. The processor 170 may output data such as a calculation result to the volatile storage device of the storage device 171, or may store such data into the auxiliary storage device via the volatile storage device.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 wireless power transfer system
5 AC power supply
11 power transmitting circuit
12 power receiving circuit
13 power converter
13a, 13b, 13c rectification circuit
14 LC filter
15 load
16 voltage detection means
17 control device
19 voltage detection means
111 power transmitting coil
112 power-transmission-side capacitor
121 power receiving coil
122 power-reception-side capacitor
131, 132, 133, 134 diode
135a, 135b, 136a, 136b semiconductor switch
141 DC inductor
142 DC capacitor
170 processor
171 storage device

1. A power receiving device of a wireless power transfer system, the power receiving device comprising:
a power receiving circuit which has a power receiving coil and receives AC power transmitted from a power transmitting circuit;
a power converter for converting AC power received by the power receiving circuit to DC power;
voltage detector to detect output voltage of the power receiving circuit;
at least one switch for performing switching between a conductive state and an opened state of a circuit between the power receiving circuit and the power converter; and
a controller to control the switch on the basis of the voltage detected by the voltage detector, wherein
by performing ON/OFF control of the switch, the controller performs switching between a power transfer period in which the power receiving circuit and the power converter are conductive with each other and a non-power-transfer period in which the power receiving circuit and the power converter are open-circuited from each other, and the controller performs control of power to be outputted, using a ratio between the power transfer period and the non-power-transfer period per a repetition cycle of ON/OFF switching of the switch.

2. The power receiving device according to claim 1, wherein
a time when the switch is switched between ON and OFF is set to be a time when an absolute value of the voltage detected by the voltage detector is 20% or less of a maximum value thereof.

3. The power receiving device according to claim 1, wherein
the switch is a semiconductor switch provided to the power converter.

4. (canceled)

5. The power receiving device according to claim 3, wherein
the power converter is a full-bridge circuit having four diodes, and
the semiconductor switches are respectively connected in series to the diodes at either upper arms or lower arms composing the full-bridge circuit.

6. The power receiving device according to claim 3, wherein
the power converter is a full-bridge circuit having four diodes, and
the semiconductor switches are respectively connected in series to the diodes at one of two legs composing the full-bridge circuit.

7. The power receiving device according to claim 3, wherein
the controller performs ON/OFF control of the semiconductor switch, using, as a unit, a half cycle of the voltage detected by the voltage detector.

8. The power receiving device according to claim 3, further comprising:
an LC filter having an inductor and connected to the power converter; and
current detector to detect current flowing through the inductor, wherein
the controller controls the semiconductor switch so as to reach a preset output power command value, on the basis of the detected current.

9. The power receiving device according to claim 8, wherein
the controller has at least three or more drive signal patterns for controlling the semiconductor switch, the drive signal patterns being different in a ratio of the power transfer period per the repetition cycle of ON/OFF switching of the semiconductor switch, and
the controller controls the semiconductor switch so as to reach the preset output power command value stepwise, using two drive signal patterns in which the ratios between the power transfer period and the non-power-transfer period are close to each other among the plurality of drive signal patterns, on the basis of a current value detected by the current detector.

10. The power receiving device according to claim 1, wherein
the switch is a bidirectional switch provided between the power receiving circuit and the power converter.

11. (canceled)

12. The power receiving device according to claim 10, further comprising:
an LC filter having an inductor and connected to the power converter; and
current detector to detector current flowing through the inductor, wherein
the controller controls the bidirectional switch so as to reach a preset output power command value, on the basis of the detected current.

13. The power receiving device according to claim 12, wherein
the controller has at least three or more drive signal patterns for controlling the bidirectional switch, the drive signal patterns being different in a ratio of the power transfer period per the repetition cycle of ON/OFF switching of the bidirectional switch, and
the controller controls the bidirectional switch so as to reach the preset output power command value stepwise, using two drive signal patterns in which the ratios between the power transfer period and the non-power-transfer period are close to each other among the plurality of drive signal patterns, on the basis of a current value detected by the current detector.

14. A wireless power transfer system comprising:
a power transmitting circuit connected to a power source and having a power transmitting coil; and
the power receiving device according to claim 1, wherein
power is transmitted from the power transmitting circuit to the power receiving device in a contactless manner.

15. The power receiving device according to claim 1, further comprising current detector to detect output current from the power converter, wherein
the controller controls the switch so as to reach a preset output power command value, on the basis of the detected current.
